(19) United States
(12) Patent Application Publication
(10) Pub. No.: US 2015/0235007 A1
(43) Pub. Date: Aug. 20, 2015

(54) SYSTEM AND METHOD FOR GENERATING A REPORT BASED ON INPUT FROM A RADIOLOGIST

(71) Applicant: KONINKLIJKE PHILIPS N.V., Eindhoven (NL)

(72) Inventors: Joost Frederik Peters, Utrecht (NL); Johannes Buurman, 's-Hertogenbosch (NL); Robbert Christiaan Van Ommering, Hapert (NL); Zharko Aleksovski, Eindhoven (NL); Iwo Willem Oscar Serlie, Eindhoven (NL); Rudolph Martherus, Vlissingen (NL)

(21) Appl. No.: 14/414,922

(22) PCT Filed: Jul. 12, 2013
(86) PCT No.: PCT/IB2013/055755

§ 371 Date: Jan. 15, 2015

Related U.S. Application Data
(60) Provisional application No. 61/674,902, filed on Jul. 24, 2012.

(51) Int. Cl. G06F 19/00; G06F 17/30

(52) U.S. Cl. CPC G06F 19/3487; G06F 19/321; G06F 17/3053; G06F 17/30864

(57) ABSTRACT

A system (100) for generating a report (142) based on input from a radiologist in response to a clinical query from a clinician, comprising: a reporting input (120) for enabling the radiologist to provide medical information (122); a reporting output (140) for generating a report (142) comprising the medical information (122); the system (100) further comprising: an interface (160) for receiving data (162) indicative of the clinical query; a reasoning engine (180) for, based on the clinical query, establishing at least one building block (182) for use by the reporting output (140) in generating the report (142), the building block specifying a form and content of at least part of the report (142); and wherein the reporting input (120) is arranged for, based on the building block (182), establishing a reporting interface (124) for use in providing the medical information.

### FIELD OF THE INVENTION

The invention relates to a system and method for generating a report based on input from a radiologist. The invention further relates to a computer program product comprising instructions for causing a processor system to perform said method.

An important purpose of radiology is to address clinical queries of clinicians. In order to obtain an answer to such a clinical query, a clinician may issue a radiology request to a radiologist. In response, the radiologist typically generates an imaging request for imaging a patient, reviews the resulting medical images, and generates a report comprising medical findings, conclusions, and other medical information. The report may be predominantly manually generated. To assist the radiologist in generating the report in a standardized and structured manner, a report template may be used. The report template may be a standard template or may be manually selected by the radiologist amongst a plurality of report templates, e.g., based on a relevance for a type of disease or a type of study.

### BACKGROUND OF THE INVENTION

It may be desirable to further assist the radiologist in generating the report so as to ensure that the report is of high quality and generated in an efficient manner.

US 20120035963 A1 describes a system including a patient medical record database that stores one or more patient records; a text extraction component that extracts, structures, and encodes clinical information in the one or more patient records; a reasoning engine that analyzes the extracted clinical information, identifies a reason for a medical report generation request, analyzes the one or more patient images, and suggests a pre-generated report template based on the identified reason; and an information integration component that integrates patient-specific information and background information into the report template in pre-specified fields to generate a custom report. The template may prompt the diagnostician to place analysis information in appropriate locations or fields, to make appropriate diagnostic interpretations, make appropriate measurements, and the like.

It is further said that in this manner, the radiologist is assisted in effectively generating a reader-independent high quality diagnostic report.

### SUMMARY OF THE INVENTION

A problem of the above system is that it is still too inconvenient for a radiologist to generate a high quality report. As a result, a clinical query may not be addressed optimally.

It would be advantageous to provide a system or method which better assists the radiologist in generating a high quality report, which addresses the clinical query in the best way possible.

To better address this concern, a first aspect of the invention provides a system for generating a report based on input from a radiologist in response to a clinical query from a clinician, comprising:

a reporting input for enabling the radiologist to provide medical information;

a reporting output for generating a report comprising the medical information;

the system further comprising:

a interface for receiving data indicative of the clinical query;

a reasoning engine for, based on the clinical query, establishing at least one building block for use by the reporting output in generating the report, the building block specifying a form and content of at least part of the report; and wherein

the reporting input is arranged for, based on the building block, establishing a reporting interface for use in providing the medical information.

In a further aspect of the invention, a method is provided for generating a report based on input from a radiologist in response to a clinical query from a clinician, comprising:

enabling the radiologist to provide medical information;

generating a report comprising the medical information;

the method further comprising:

receiving data indicative of the clinical query;

based on the clinical query, establishing at least one building block for use in generating the report, the building block specifying a form and content of at least part of the report; and

based on the building block, establishing a reporting interface for use in providing the medical information.

In a further aspect of the invention, a computer program product is provided comprising instructions for causing a processor system to perform the method set forth.

The aforementioned measures assist the radiologist in generating a report in response to a radiology request from a clinician. Here, it is noted that the term radiologist refers to a medical specialist who interprets medical images, and as such, may include residents and trainee radiologist. For enabling generating the report, a reporting input is provided which captures medical information being provided by the radiologist. The medical information may be provided in the form of, e.g., dictations, typing actions, etc. The reporting input obtains said input and, if necessary, converts it into an electronic form. Furthermore, a reporting output is provided. The reporting output generates a report which comprises said medical information. The report is generated in electronic form.

The system further comprises an interface for receiving data indicative of a clinical query. Hence, the data comprises or allows inference of the clinical query. The clinical query represents a query of the referring clinician. The system further comprises a reasoning engine for, based on the clinical query, establishing at least one building block. The building block constitutes data which specifies a form and content of at least part of the report. The reporting output uses the building block to generate the report, e.g., by formatting the part of the report associated with the building block accordingly. The reasoning engine thus analyzes the clinical query so as to obtain a form and content of the report, and encodes said form and content into a data package which serves for generating the report. The building block may be one of a plurality of building blocks, e.g., with each of the plurality of building blocks specifying a form and content of a different part of the report.

The reporting input is arranged for, based on the building block, establishing a reporting interface for use in providing the medical information. Hence, the radiologist may, or may be required to, use the reporting interface to provide the medical information. The reporting interface itself is an interface that enables interaction between the radiologist and the system, i.e., a user interface such as a graphical user interface. Inherently, the reporting interface determines a form and content of the input provided by the radiologist since it, e.g., determines reporting capabilities and/or sets reporting limitations. The reporting input establishes the reporting interface in that it selects the reporting interface amongst a plurality of reporting interfaces, customizes a generic reporting interface, etc.

The present invention is at least in part based on the following insights. When generating a report to address a clinical query, the form and content of the report affect how well the report addresses the clinical query. The clinical query is indicative of a form and content of the report; the report more optimally addresses the clinical query as a reporting need of the clinician is derived from the clinical query itself by the reasoning engine. By anticipating the form and content from the clinical query and encoding said form and content into a building block, the reporting output is enabled to appropriately generating the report.

Since the building block constitutes an autonomous data package, i.e., essentially independent of the report, the building block can be used throughout the system. By providing a reporting input which uses the building block to establish a reporting interface, the interaction between the radiologist and the system can be at least in part determined by the anticipated form and content of the report. Consequently, the system is enabled to assist the radiologist in providing the input, e.g., by providing advanced reporting capabilities or tools, or setting appropriate limitations, in view of the report that is to be generated.

Advantageously, since the building block allows the reporting input to anticipate a form and content of the report that is to be generated by the system, it therefore enables the reporting input to establish a reporting interface that is well suited for generating such a report. Advantageously, instead of providing information placeholders which cause a radiologist, when being confronted therewith, to be prompted to place medical information therein, the radiologist is actively assisted in the providing of the medical information. That is, a customized reporting interface is provided to the radiologist, enabling him to provide the medical information in the most optimal way.

Optionally, the network interface is arranged for receiving a data representation of a radiology request, and the reasoning engine is arranged for identifying the clinical query based on said data representation of the radiology request.

The inventors have recognized that the radiology request itself is indicative of the clinical query. By receiving a data presentation of the radiology request, i.e., in electronic form, the reasoning engine can, based on the radiology request, identify the clinical query. Advantageously, it is not needed to separately obtain data indicative of the clinical query since the radiology request is typically readily available to the system.

In an embodiment, the building block specifies a hanging protocol, and the reporting input is arranged for, as part of the reporting interface, displaying one or more medical images in accordance with the hanging protocol.

The term hanging protocol refers to one or more rules that specify a way of presenting images. The inventors have recognized that the clinical query is indicative of a particular hanging protocol. The reasoning engine establishes the building block so as to be indicative of the hanging protocol. This enables the reporting input to display one or more medical images within the reporting interface in accordance with the particular hanging protocol. Advantageously, the one or more medical images are presented such that they enable efficient providing of medical information relevant to the clinical query.

Optionally, the reporting output is arranged for including the one or more medical images in the report based on the hanging protocol.

By including the one or more medical images in the report based on the hanging protocol, the one or more medical images are presented in a same way to the clinician when viewing the report as to the radiologist when providing the medical information for the report. Advantageously, the clinician automatically obtains a presentation of the one or more medical images that is relevant to the clinical query.

Optionally, the hanging protocol defines at least one of: a display order, a display layout, a distribution over multiple displays, a display size, a window width parameter, a window level parameter, a pan parameter, a zoom parameter, of the one or more medical images. Said parameters are of particular relevance when displaying medical images.

In a further embodiment, the building block is indicative of a reporting tool for use in providing the medical information, and the reporting input is arranged for establishing the reporting tool as part of the reporting interface. The inventors have recognized that the clinical query is indicative of a reporting tool which may be advantageously used in providing the medical information. The building block is, or can be established to be, indicative of the reporting tool, therefore enabling the reporting input to establish the reporting tool. The radiologist is thus better assisted in providing the medical information.

Optionally, the reporting tool is an image measurement tool for enabling the radiologist to perform an image measurement. The clinical query may be indicative that an image measurement is needed or may be advantageously used in generating the report. The reporting input thus establishes an image measurement tool based on the building block.

Optionally, the reporting input is arranged for establishing the image measurement tool by at least one of: customizing a generic image measurement tool; automatically selecting the image measurement tool from a plurality of image measurement tools; and ranking a plurality of image measurement tools based on a relevance for the clinical query for enabling the radiologist to manually select the image measurement tool.

Optionally, the building block is indicative of a clinical tolerance, and the reporting input is arranged for configuring the image measurement tool based on the clinical tolerance. The clinical query may be indicative of a clinical tolerance to be used in generating the report. The reporting input thus configures the image measurement tool accordingly.

Optionally, the reporting tool is an auto-completion tool providing a plurality of medical terms for auto-completing a partial medical term provided by the radiologist. The clinical query may be indicative of medical terms that are of relevance in generating the report. The reporting input thus establishes an auto-completion tool that assists the radiologist in providing the medical information by providing a plurality of medical terms that auto-complete a partial medical term provided by the radiologist. Advantageously, since the use of the medical terms provided by the auto-completion tool is at least suggested and may be even mandatory, the computer interpretability of the provided medical information is increased.

Optionally, the auto-completion tool is arranged for ranking the plurality of medical terms based on a relevance for the clinical query. Hence, medical terms which are of relevance to the clinical query are easily noticed and selected by the radiologist.

Optionally, the reporting input is arranged for enabling the radiologist to provide the medical information throughout a radiology workflow; and the reasoning engine is arranged for updating the building block during the radiology workflow based on requests and/or results in the radiology workflow. The building block thus is a dynamic building block as it is updated throughout the radiology workflow based on requests and/or results in the radiology workflow. Said requests and/or results provide additional information which may not be derivable from or anticipated by the clinical query. The building block is updated throughout the radiology workflow to take into account said additional information.

Optionally, the building block is updated based on at least one of: a radiology request, an imaging request and one or more medical images.

Optionally, the reasoning engine is arranged for establishing the building block further based on a report template. A report template provides information placeholders in a structured manner and thus is indicative of a form and content of a corresponding report. In case the report template is considered to be suitable for at least in part addressing the clinical query, e.g., due to the radiologist selecting the report template, the report template can be advantageously used in establishing the building block, e.g., by using the report template as a basis and the clinical query for refinement, or vice versa.

Optionally, the reasoning engine is arranged for selecting the report template based on the clinical query. Hence, a report template is automatically identified, without a need for the radiologist to manually select the report template.

Optionally, the building block is arranged for storing the medical information as reported using the reporting interface, and the reporting output is arranged for generating the report based on the medical information stored in the building block. The building block thus serves as container for the medical information. Therefore, the building block not only specifies the form and content of at least part of the report, i.e., identifies or defines said form and content, but also stores the content itself. In particular, the building block can be used to store the medical information that is reported using the reporting interface.

Optionally, the system is constituted at least in part by a Picture Archiving and Communication System, and/or a Radiology Information System.

It will be appreciated by those skilled in the art that two or more of the above-mentioned embodiments, implementations, and/or aspects of the invention may be combined in any way deemed useful. Further, within the scope of the present invention, the skilled person could readily envisage more examples of building blocks that could facilitate generation of high-quality reports by the radiologist.

Modifications and variations of the method and/or the computer program product, which correspond to the described modifications and variations of the system, can be carried out by a person skilled in the art on the basis of the present description.

A person skilled in the art will appreciate that the method may be applied to multi-dimensional image data, e.g. to two-dimensional (2-D), three-dimensional (3-D) or four-dimensional (4-D) images. A dimension of the multi-dimensional image data may relate to time. For example, a three-dimensional image may comprise a time domain series of two-dimensional images. The image may be acquired by various acquisition modalities such as, but not limited to, standard X-ray Imaging, Computed Tomography (CT), Magnetic Resonance Imaging (MRI), Ultrasound (US), Positron Emission Tomography (PET), Single Photon Emission Computed Tomography (SPECT), and Nuclear Medicine (NM).

The invention is defined in the independent claims. Advantageous yet optional embodiments are defined in the dependent claims.

### BRIEF DESCRIPTION OF THE DRAWINGS

These and other aspects of the invention are apparent from and will be elucidated with reference to the embodiments described hereinafter. In the drawings,

FIG. 1 shows a system according to the present invention, for generating a report based on input from a radiologist in response to a clinical query from a clinician;

FIG. 2 shows a method according to the present invention;

FIG. 3 shows a computer program product according to the present invention;

FIG. 4a shows three medical images corresponding to coronal, sagittal and transverse views of a patient being displayed according to a hanging protocol;

FIG. 4b shows four medical images corresponding to left and right cranio-caudal views and left and right mediolateral oblique views of a patient being displayed according to a further hanging protocol;

FIG. 5a shows an auto-completion tool providing a plurality of medical terms for auto-completing a partial medical term provided by the radiologist;

FIG. 5b shows the auto-completion tool ranking the plurality of medical terms based on a relevance for the clinical query;

FIG. 6 shows an image measurement tool being provided to enable the radiologist to quantify a coverage of a femoral head at the acetabulum;

FIG. 7a shows a thorax image;

FIG. 7b shows an image measurement tool being provided to enable the radiologist to perform an initial length measurement in the thorax image; and

FIG. 7c shows further image measurement tools being provided based on a result of the initial length measurement.

### DETAILED DESCRIPTION OF EMBODIMENTS

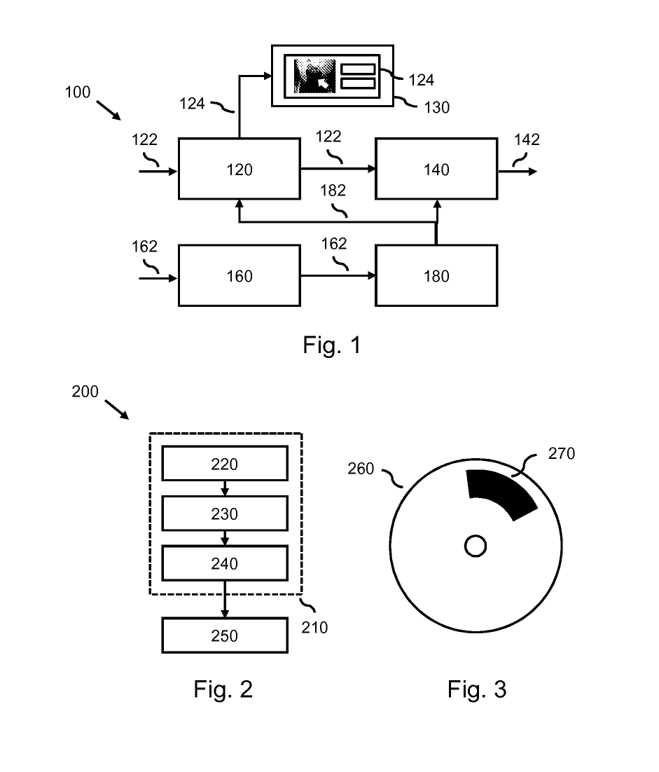

FIG. 1 shows a system 100 for generating a report 142 based on input 122 from a radiologist in response to a clinical query from a clinician. The system 100 comprises a reporting input 120 for enabling the radiologist to provide medical information 122. The reporting input 120 may take the form of, e.g., a reporting console which is connected to a user interface device such as a keyboard, mouse, microphone, etc., and which receives data comprising the medical information 122 from the user interface device. The system 100 further comprises a reporting output 140 for generating a report 142 comprising the medical information 122. For that purpose, the reporting input 120 is shown to be connected to the reporting output 140 so as make the medical information 122 available. The report 142 is typically generated in electronic form, e.g., as a computer readable file.

The system 100 further comprises a network interface 160 for receiving data 162 indicative of a clinical query. Said data 162 may be received from inside the system or from outside the system. For example, in case the system 100 is constituted by a combination of a Picture Archiving and Communication System (PACS) and a Radiology Information System (RIS), the data 162 may be received from the RIS if the data 162 is available thereon. Alternatively or additionally, the data 162 may be received from a Hospital Information System (HIS) in which the system 100, e.g., said PACS and RIS, is located. The data 162 may constitute a data representation of the radiology request 162.

The system 100 further comprises a reasoning engine 180 for, based on the clinical query, establishing at least one building block 182 for use by the reporting output 140 in generating the report 142. The building block 182 specifies a form and content of at least part of the report 142. FIG. 1 shows the reasoning engine 180 receiving the data 162 indicative of the clinical query from the network interface 160. In order to obtain the clinical query therefrom, the reasoning engine 180 may be arranged for analyzing said data 162. For example, the reasoning engine 180 may analyze the radiology request 162 to identify the clinical query in case the data 162 is a data representation of said radiology request 162. The reasoning engine makes the building block 182 available to the reporting output 140. This may comprise making the building block 182 available in, e.g., a database of the RIS.

The reporting input 120 is further arranged for, based on the building block 182, establishing a reporting interface 124 for use in providing the medical information. For that purpose, the reporting input 120 is shown to receive the building block 182 from the reasoning engine 180. FIG. 1 shows the reporting interface 124 comprising a graphical user interface which is shown on a display 130, with the display 130 being connected to the reporting input. The reporting input 120 and the display 130 may together take form of a workstation which is part of, or connected to the HIS. However, this is not a limitation.

The operation of the system 100 may be briefly explained as follows. The network interface 160 receives data 162 indicative of a clinical query. The reasoning engine 180 establishes a building block 182 based on the clinical query, with the building block 182 specifying a form and content of at least part of a report 142. The reporting input 120 establishes a reporting interface 124 based on the building block 124. The radiologist uses the reporting interface in providing medical information 122. The reporting input 120 makes the medical information 122 available to the reporting output 140. The reporting output 140 generates a report 142 based on the building block 182 and the medical information 122.

FIG. 2 shows a method 200 for generating a report based on input from a radiologist in response to a clinical query from a clinician. The method 200 comprises, in a step titled “PROVIDING OF MEDICAL INFORMATION”, enabling 210 the radiologist to provide medical information. The method 200 further comprises, in a step titled “GENERATING REPORT COMPRISING THE MEDICAL INFORMATION”, generating 250 a report comprising the medical information. The method 200 further comprises the following steps, which are shown in FIG. 2 to constitute sub-steps of the step of enabling 210 the radiologist to provide medical information. However, this is not a limitation. A sub-step, titled “RECEIVING CLINICAL QUERY”, comprises receiving 220 data indicative of the clinical query. A further sub-step, titled “ESTABLISHING BUILDING BLOCK BASED ON CLINICAL QUERY”, comprises, based on the clinical query, establishing 230 at least one building block for use in generating the report, the building block specifying a form and content of at least part of the report. A last sub-step, titled “ESTABLISHING REPORTING INTERFACE BASED ON BUILDING BLOCK”, comprises, based on the building block, establishing 240 a reporting interface for use in providing the medical information.

The method 200 may correspond to an operation of the system 100. However, it is noted that the method 200 may also be performed in separation of the system 100.

FIG. 3 shows a computer program product 270 comprising instructions for causing a processor system to perform the aforementioned method 200. The computer program product 270 may be comprised on a computer readable medium 260, for example in the form of as a series of machine readable physical marks and/or as a series of elements having different electrical, e.g., magnetic, or optical properties or values.

The operation of the system 100 may be explained in more detail as follows. The reporting input 120 may establish the reporting interface 124 so as to provide one or more interface elements to assist the radiologist in providing the medical information 122. Said elements thus form part of the reporting interface 124. An example of such an interface element concerns the display of one or more medical images as part of the reporting interface 124. More specifically, the building block 182 may specify a hanging protocol 300, 302. The hanging protocol 300, 302 may define one or more of a group of: a display order, a display layout, a distribution over multiple displays, a display size, a window width parameter, a window level parameter, a pan parameter, a zoom parameter, of the one or more medical images. The reporting input 120 may be arranged for, as part of the reporting interface 124, displaying one or more medical images in accordance with the hanging protocol.

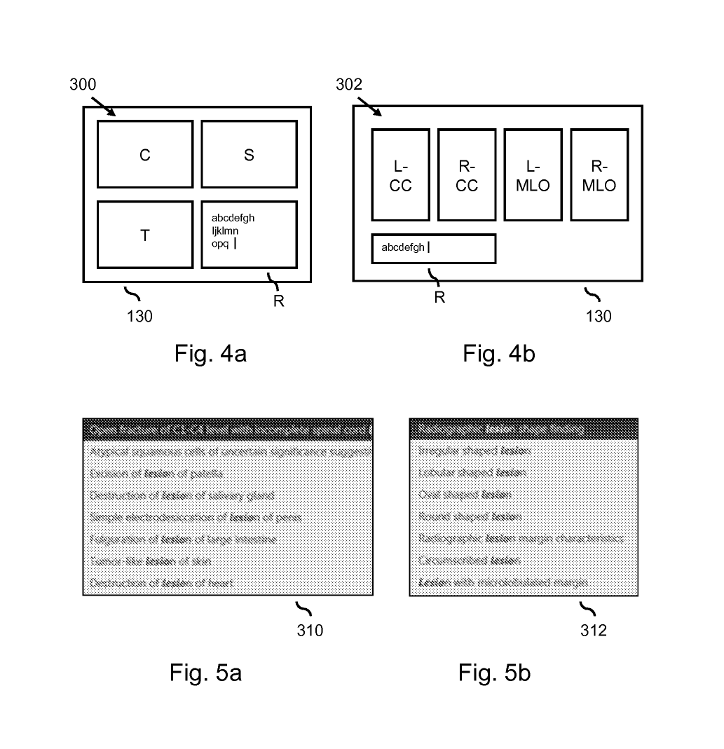

FIG. 4a shows a first example of displaying medical images C, S, T according to a hanging protocol 300. Here, the hanging protocol 300 may specify that a coronal image C, i.e., showing a coronal view of the patient, is to be displayed in a top-left corner of the display 130. Moreover, the hanging protocol 300 may specify that a sagittal image S, i.e., showing a sagittal view of the patient, is to be displayed in a top-right corner of the display 130. Lastly, the hanging protocol 300 may specify that a transverse image T, i.e., showing a transverse view of the patient, is to be displayed in a bottom-left corner of the display 130. The hanging protocol 300 may follow directly or indirectly out of the clinical query. For example, the clinical query may indicate that examination of the spine of a patient is requested. The reasoning engine 180 may determine, e.g., based on medical data such as medical guidelines, clinical protocols, etc., that the medical images obtained are to be displayed according to a particular hanging protocol during review by the radiologist, i.e., in this particular example, according to the hanging protocol illustrated in FIG. 4a.

FIG. 4a further shows the reporting input 120 establishing a reporting window R on the display 130 as part of the reporting interface 124. The radiologist may use the reporting window R to enter the medical information 122 such as medical findings, conclusions, and other medical information. The reporting input 120 may, also in general, be arranged for storing the medical information 122 as reported by the radiologist in the building block 182. Moreover, the reporting output 140 may be arranged for generating the report 142 based on the medical information stored in the building block 182. Hence, the reporting input 120 may not need to provide the medical information 122 directly to the reporting output 140, but may rather provide the building block 182, e.g., directly or via, e.g., the RIS.

The reporting output 140 may be arranged for including the one or more medical images C, S, T in the report 142 based on the hanging protocol 300. Hence, a viewer of the report 142 may be provided with a display of the medical images C, S, T according to the hanging protocol 300. This enables, amongst others, the following. Several sections of the report 142 may each be associated with a different hanging protocol 300. Hence, the medical images displayed in each of the different sections of the report 142 may be displayed according to different hanging protocols 300. For that purpose, a plurality of building blocks may be provided, with each of the plurality of building blocks specifying a form and content of a section or subsection of the report 142. All or several of the plurality of building blocks may specify a hanging protocol 300. Hence, the reporting output 140 is enabled to generated said report 142 having different display of images in different sections.

It is noted that, in addition or alternatively to the one or more medical images being included in the report 142 based on the hanging protocol 300, the hanging protocol 300 itself may be included in the report 142. This enables a report viewer to display the one or more medical images based on the hanging protocol 300 at a time of viewing the report 142. Hence, it is not needed to explicitly hang the medical images within the report 142 based on the hanging protocol 300. Rather, the hanging may be performed at a time of viewing. This enables also different viewing modes, including, e.g., an optimized presentation mode.

FIG. 4b shows another example of displaying medical images LCC, RCC, LMLO, RMLO according to a hanging protocol 302. Here, the hanging protocol 302 may specify that a left cranio-caudal image LCC and right cranio-caudal image RCC are to be displayed side-by-side on the display 130, and that a left mediolateral oblique image LMLO and a right mediolateral oblique image RMLO are also to be displayed side-by-side on the display 130. Moreover, the hanging protocol 302 may specify that the cranio-caudal images LCC, RCC are to be displayed on a left-hand side of the display 130, and the mediolateral oblique images LMLO, RMLO are to be displayed on a right-hand side of the display 130. The hanging protocol 302 may follow directly or indirectly out of the clinical query, e.g., the clinical query may indicate that a mammography is requested, and the reasoning engine 180 may establish the hanging protocol 302 based on a mammography protocol.

In general, the hanging protocol 300 may be optimized based on various parameters, such as, e.g., available display space, user information, lighting conditions, etc.

FIGS. 5a-7c relate to the following: the building block 182 may be indicative of a reporting tool for use in providing the medical information, and the reporting input 120 may be arranged for establishing the reporting tool as part of the reporting interface 124. Hence, the reporting input 120 establishes a reporting tool as an interface element.

FIG. 5a shows a first example of a reporting tool for use in providing the medical information. Here, an auto-completion tool 310 is shown, which provides a plurality of medical terms for auto-completing a partial medical term provided by the radiologist. In this particular example, the partial medical term as, e.g., entered by the radiologist in the reporting window R of FIGS. 4a and 4b, is “lesio”, i.e., the first letters of the medical term “lesion”. In response to the partial input provided so far, the auto-completion tool 310 shows a plurality of medical terms comprising the partial medical term “lesio”, i.e., a plurality of medical terms related to lesions. The auto-completion tool 310 may be arranged for enabling the radiologist to select one of the plurality of medical terms, thus avoiding a need to complete the partial input. In the example of FIG. 5a, a top-one of the plurality of medical terms is shown using inverted intensities. This may denote a default selection, e.g., a medical term that is automatically selected in the auto-completion in case the auto-completion is effected. The ranking of the plurality of medical terms may be based on a match quality between the partial medical term and each of the plurality of medical terms.

In general, the auto-completion tool 310 may establish the plurality of medical terms from a medical lexicon. The auto-completion tool 310 may select the medical lexicon amongst a plurality of specialist medical lexicons based on a relevance for the clinical query. Additionally or alternatively, a comprehensive general medical lexicon may be used.

FIG. 5b shows a result of the auto-completion tool 312 being arranged for ranking the plurality of medical terms based on a relevance for the clinical query. A top-one of the plurality of medical terms may be a medical term that is most relevant to the clinical query, whereas the following medical terms may be of lesser or equal relevance. For example, if the clinical query indicates that “appendicitis” should be ruled out, it is likely that medical terms will be used that describe abdominal features related to the colon, and it is less likely that a medical term will be used that describes a broken bone. Hence, medical terms which are related to the colon may be displayed more prominently, e.g., on top of a list, than medical terms related to broken bones, which thus may be displayed less prominently.

Additionally or alternatively, the ranking of the plurality of medical terms may be based on an image context and/or an imaging modality. For example, an abdominal image will less likely be described with medical terms that relate to the brain than with medical terms that relate to the liver. Additionally or alternatively, the ranking of the plurality of medical terms may be based on a lesion context in which semantically related medical terms which describe nearby lesions, e.g., in time and/or location, are more likely to be relevant than other medical terms. Additionally or alternatively, the ranking of the plurality of medical terms may be based on a user interface context in which medical terms are ranked based on previous user interface actions. For example, if a previous user input relates to a liver segment, it is likely that another liver or abdominal related medical term may be used. In general, said ranking may be based on requests and/or results in the radiology workflow.

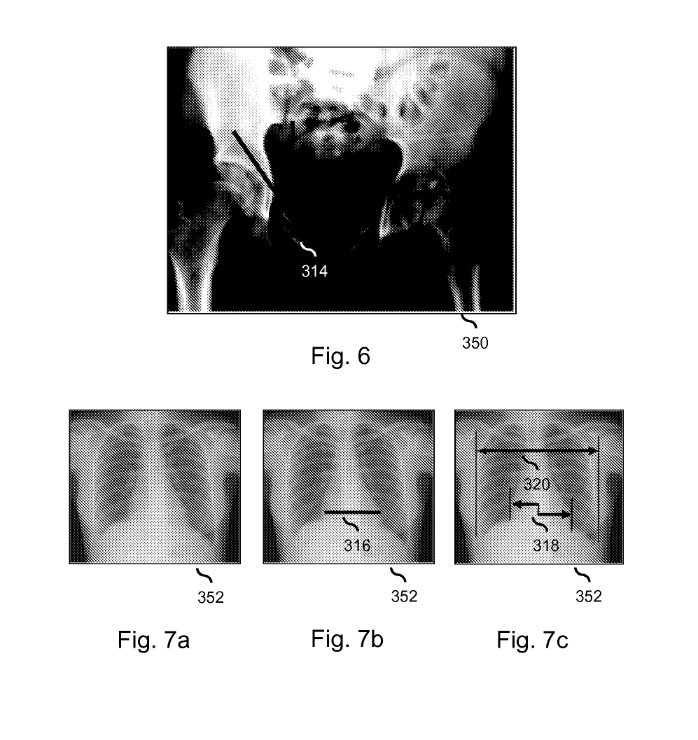

FIG. 6 and FIGS. 7a-c show further examples of a reporting tool for use in providing the medical information. Here, the reporting tool is an image measurement tool 314-320 for enabling the radiologist to perform an image measurement.

FIG. 6 shows a first example of the image measurement tool. In the context of this example, the radiologist is tasked with examining the femoral head for adequate coverage based on a medical image 350. Adequate coverage is defined by a so-termed center-edge angle which is formed by two lines, each originating at the center of the femoral head, with one line extending vertically and the second extending to the lateral acetabulum. Coverage of the femoral head is considered adequate if the angle measures at least 25°. The reporting input 120 may be arranged for establishing a suitable image measurement tool 314 for use in reporting the angle based on the building block 182. Furthermore, the reporting input 120 may store the angle as measured by the radiologist in the building block 182.

FIGS. 7a-7c show a further example of an image measurement tool. In the context of this example, the radiologist is tasked with measuring the Cardiothoracic Area Ratio (CTR). This involves two length measurements and a computation of their ratio. The present invention may be advantageously applied in measuring the CTR as follows. When a thorax image 352 is loaded, as shown in FIG. 7a, an initial image measurement tool 316 is established for performing an initial length measurement. A result of this is shown in FIG. 7b. Based on the initial length measurement, the system 100 anticipates that a CTR measurement is required and automatically creates and initializes a first image measurement tool 318 and a second image measurement tool 320 for obtaining the two length measurements. The results of the measurements and/or the computation of their ratio may then be stored in one or more building blocks to be used by the reporting output 140 in generating one or more sections of the report 124. Effectively, the image measurement tools 318, 320 are linked to said one or more sections of the report 124 via the one or more building blocks. Hence, the system 100 may automatically generate said sections so as to describe and/or summarize the CTR.

In general, the reporting input 120 may be arranged for establishing the image measurement tool 314-320 by customizing a given image measurement tool, e.g., by suitably choosing parameters. An example of a parameter may be a clinical tolerance which is applicable to the image measurement. The building block 182 may be indicative of the clinical tolerance. The reporting input 120 may be arranged for configuring the image measurement tool 314-320 based on the clinical tolerance. The reporting output 140 may be arranged for including the clinical tolerance the report 124, e.g., in a section in which also the results of the image measurement are described and/or summarized. This way, the clinical tolerance may determine a manner of presenting the results of the image measurement.

The image measurement tool may be a generic image measurement tool, and the reporting input 120 may be arranged for customizing the generic image measurement tool so as to obtain a specialized image measurement tool for the task at hand. Here, the task at hand may be anticipated from the clinical query. The reporting input 120 may also establish the image measurement tool 314-320 by automatically selecting the image measurement tool from a plurality of image measurement tools, e.g., based on a relevance for the clinical query and thus on an anticipated relevance for the task at hand. The reporting input 120 may also establish the image measurement tool 314-320 by ranking a plurality of image measurement tools based on a relevance for the clinical query so as to enable the radiologist to manually select the image measurement tool 314-320. Alternatively or additionally to ranking the plurality of image measurement tools, relevant image measurement tools may be displayed more prominently, or may be visualized based on a primary and secondary arrangement. It is noted that the reporting tool may be any image-based tool. For example, the reporting tool may be an image annotation tool which allows the radiologist to add annotations to the one or more medical images, such as arrows, text, etc.

In general, the reporting input 120 may be arranged for enabling the radiologist to provide the medical information 122 throughout a radiology workflow, and the reasoning engine 180 may arranged for updating the building block 182 during the radiology workflow based on requests and/or results in the radiology workflow. For example, the building block 182 may be updated based on at least one of: a radiology request, an imaging request and one or more medical images. The reasoning engine 180 may arranged for establishing the building block 182 further based on a report template. For example, the reasoning engine may be arranged for selecting the report template based on the clinical query. Moreover, it will be appreciated that the reporting interface 124, and as such the reporting tools which are part of the reporting interface 124, may also be directly established based on the clinical query. Hence, even though the building block 182 is indicative of an anticipated form and content of the report 124 and thus allows the reporting input 120 to establish a suitable reporting interface 124, the use of said building block 182 is optional.

In general, a building block according to the present invention may be advantageously applied in a radiology or clinical workflow as follows.

A clinical query may cause a plurality of building blocks to be established for use in the radiology workflow, i.e., from clinical query to report. Moreover, from the clinical query, an order may be established in which the building blocks are expected to be used. An initial plurality of building blocks may be obtained from a report template. The building blocks may then develop in that, throughout the radiology workflow, the building blocks may be updated according to additional knowledge. The additional knowledge may include requests and/or results in the radiology workflow such as an imaging request, a type of medical image, a quality of the medical image or of the patient preparation, etc.

The building blocks may capture medical as well as other information. For example, a technologist who creates a medical image may store information in the building block which is used in describing the medical image. The information may be, e.g., a remark on the quality of the patient preparation. Similarly, a resident who aids the radiologist in generating the report may store information in one or more building blocks. Another example is that, when generating the report based on one or more building blocks, the building blocks may comprise the viewing conditions which were used to gather the medical information comprised in the building blocks. Said viewing conditions may be included in the report, and/or the report may be generated based on said viewing conditions. The building blocks may be re-used, in that a building block may be used several times to capture medical information. For example, a building block may describe how to report a lesion in a liver, with said building block being used to report several lesions in the liver.

The building blocks may, throughout the radiology workflow, describe the elements of the report and how the elements are constructed. For example, a building block may describe of a lesion in a particular organ. The elements may constitute sections, subsections or other parts of the report. The description may be linked to reporting tools to obtain the particular knowledge, e.g., image measurement tools, either explicitly by comprising link information, or implicitly by allowing the reporting input to establish a reporting tool from a building block. Thus, in general, a building block may form a link between a reporting tool and an element of the report. The reporting tool may be specialized for a task at hand and may be adapted to current conditions. For example, a radiologist may need to measure a size of a lesion. An image measurement tool may be established based on a type of the medical image in which the lesion is present and the viewing conditions, e.g., 2D or 3D visualization. The building blocks may be linked to corresponding sections in a reference manual. The building blocks may describe viewing conditions which are needed to obtain the descriptions. Viewing conditions may include visualization modes and navigation modes. A navigation mode may describe how to navigate through a particular organ. A choice of an optimal navigation mode may depend on the patient preparation and data. A building block may describe a mandatory element and/or an optional element of the report. The system may automatically determine which building blocks are mandatory and which are optional in generating the report, e.g., based on a reporting template or other documents.

It will be appreciated that the invention also applies to computer programs, particularly computer programs on or in a carrier, adapted to put the invention into practice. The program may be in the form of a source code, an object code, a code intermediate source and an object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for generating a report based on input from a radiologist in response to a clinical query from a clinician, comprising:
a reporting input for enabling the radiologist to provide medical information;
a reporting output for generating a report comprising the medical information;
the system further comprising:
an interface for receiving data indicative of the clinical query;
a reasoning engine for, i) analyzing the clinical query to determine a form and content of at least part of the report, and ii) encoding the form and content into a data package representing at least one building block for use by the reporting output in generating the report; and wherein
the reporting input is arranged for, based on the building block, establishing a graphical user interface representing a customized reporting interface for use by the radiologist in providing the medical information.

2. The system according to claim 1, wherein:
the interface is arranged for receiving a data representation of a radiology request; and
the reasoning engine is arranged for identifying the clinical query based on said data representation of the radiology request.

3. The system according to claim 1, wherein the building block specifies a hanging protocol, and wherein the reporting input is arranged for, as part of the graphical user interface, displaying one or more medical images (C, S, T, LCC, RCC, LMLO, RMLO) in accordance with the hanging protocol.

4. The system according to claim 3, wherein the reporting output is arranged for including the one or more medical images (C, S, T, LCC, RCC, LMLO, RMLO) in the report based on the hanging protocol.

5. The system according to claim 3, wherein the hanging protocol defines at least one of: a display order, a display layout, a distribution over multiple displays, a display size, a window width parameter, a window level parameter, a pan parameter, a zoom parameter, of the one or more medical images (C, S, T, LCC, RCC, LMLO, RMLO).

6. The system according to claim 1, wherein the building block is indicative of a reporting tool for use in providing the medical information, and wherein the reporting input is arranged for establishing the reporting tool as part of the graphical user interface.

7. The system according to claim 6, wherein the reporting tool is an image measurement tool for enabling the radiologist to perform an image measurement.

8. The system according to claim 7, wherein the reporting input is arranged for establishing the image measurement tool by at least one of:
customizing a generic image measurement tool;
automatically selecting the image measurement tool from a plurality of image measurement tools; and
ranking a plurality of image measurement tools based on a relevance for the clinical query for enabling the radiologist to manually select the image measurement tool.

9. The system according to claim 7, wherein the building block is indicative of a clinical tolerance, and wherein the reporting input is arranged for configuring the image measurement tool based on the clinical tolerance.

10. The system according to claim 6, wherein the reporting tool is an auto-completion tool providing a plurality of medical terms for auto-completing a partial medical term provided by the radiologist.

11. The system according to claim 10, wherein the auto-completion tool is arranged for ranking the plurality of medical terms based on a relevance for the clinical query.

12. The system according to claim 1, wherein:
the reporting input is arranged for enabling the radiologist to provide the medical information throughout a radiology workflow; and
the reasoning engine is arranged for updating the building block during the radiology workflow based on requests and/or results in the radiology workflow.

13. The system according to claim 12, wherein the building block is updated based on at least one of: a radiology request, an imaging request and one or more medical images.

14. (canceled)

15. (canceled)

16. (canceled)

17. (canceled)

18. Method for generating a report based on input from a radiologist in response to a clinical query from a clinician, comprising:
enabling the radiologist to provide medical information;
generating a report comprising the medical information;
the method further comprising:
receiving data indicative of the clinical query;
analyzing the clinical query to determine a form and content of at least pall of the report;
encoding the form and content into a data package representing at least one building block for use in generating the report; and
based on the building block, establishing a graphical user interface representing a customized reporting interface for use by the radiologist in providing the medical information.

19. A computer program product comprising instructions for causing a processor system to perform the method according to claim 18.
